(19) United States
(12) Patent Application Publication
(10) Pub. No.: US 2017/0061708 A1
(43) Pub. Date: Mar. 2, 2017

(54) METHOD, APPARUTUS AND SYSTEM FOR MANAGING VEHICLE INTERLOCK APPLICATION

(71) Applicant: Hyundai Motor Company, Seoul (KR)

(72) Inventor: Un Hwan Sol, Yongin (KR)

(21) Appl. No.: 14/962,811

(22) Filed: Dec. 8, 2015

(30) Foreign Application Priority Data
Aug. 27, 2015 (KR) 10-2015-0121017

(51) Int. Cl. G07C 5/00; H04W 8/24; G07C 5/08; G06F 9/445

(52) U.S. Cl. CPC G07C 5/008; G06F 8/65; G06F 8/61; H04W 8/245; G07C 5/0808; G07C 5/085

(57) ABSTRACT

A method performed at a vehicle terminal for managing a vehicle engagement application installed at a mobile device includes: establishing a data communication link with a mobile device; receiving a notification status corresponding to the vehicle engagement application via the data communication link, the notification status indicating whether the vehicle engagement application is up-to-date; and determining whether it is necessary to update the vehicle engagement application based on the notification status. A predetermined control signal for managing the vehicle engagement application is transmitted to the mobile device according to the determination.

### CROSS-REFERENCE TO RELATED APPLICATION

This application claims priority to and the benefit of Korean Patent Application No. 10-2015-0121017, filed on Aug. 27, 2015 in the Korean Intellectual Property Office, the disclosure of which being hereby incorporated by reference as if fully set forth herein.

### TECHNICAL FIELD

The disclosure relates generally to a method and an apparatus for controlling engagement between a vehicle terminal and a mobile device, and more particularly to a system, a device and a method, adapted in a vehicle, operable to, when the mobile device accesses to vehicle terminal, automatically check a upgrade notice about a vehicle engagement application installed in a mobile device engaged with the vehicle.

### BACKGROUND

Many vehicles include a mechanism combining various electric control devices with a mechanical structure. The electric control devices can receive various status information of the vehicle from sensors installed throughout vehicle. Based on received status information, the electric control devices control parts of the vehicle more effectively so as to enhance driving safety, fuel efficiency, and comfort. Further, vehicles can include a self-diagnosis unit for detecting a control signal outputted from the electric control device and a result of operation in response to the control signal. When an error or defect is found, the self-diagnosis unit can generate and store a diagnostic code.

Accordingly, when a driver thinks that his or her vehicle has a problem and visits a service center such as an auto mechanic, an employee in the center uses a particular device such as Hi-tech Car Scanner for vehicle inspection, and replaces or repairs a component of vehicle in response to an inspection result. Since a driver or operator should visit at the center to check whether any component of vehicle does not work, more serious problems can occur when the driver or operator is not aware of a minor issue in the vehicle and continues to drive the vehicle without a care.

Such vehicles can include a vehicle terminal for executing an audio-video (AV) function, such as playing an audio/video signal stored in various computer-readable mediums, and/or a navigation function for guiding a driver along a driving route to a destination and providing traffic information. The vehicle terminal can be generally called a telematics, which is a compound word of telecommunication and information and configured to access a control center capable of providing a management service via a wireless communication and to receive information provided by the control center.

The vehicle terminal transmits vehicle information including mileage, self-diagnosis data, operation data, etc. to a service server located at the control center, and then receives information provided from the service server. In order to access the service server located at the control center via a wireless network, a communication modem is required. Thus, the vehicle terminal can use the driver's mobile device as the communication modem. For example, when the vehicle terminal is coupled to the driver's mobile device, the vehicle information is delivered to a vehicle engagement application in the driver's mobile device. The vehicle engagement application shows the vehicle information transmitted from the vehicle terminal in a predetermined format, and access to the service server in the control center to thereby transfer the vehicle information.

Further, the mobile device receives a management service provided by the service server at the control center, and when engaging with the vehicle terminal, arranges execution of the management service in response to a vehicle operation. In addition, when there is a Bluetooth connection between the vehicle terminal and driver's mobile device, a telephonic connection with a consultant working for the control center can be established. In order for the vehicle terminal to engage with the mobile device, the vehicle engagement application providing engagement between the vehicle terminal and the mobile device should be installed in the mobile device.

Accordingly, installing the vehicle engagement application can be difficult because a driver who owns the mobile device has to access an application market, such as Apple Store or Android Market, to search and download the vehicle engagement application for the corresponding vehicle. Further, accessing the service server at the control center can be problematic because a driver must connect the mobile device to the vehicle terminal using USB cable and manually execute the vehicle engagement application installed at the mobile device in order to use the management service.

However, when the vehicle engagement application installed at the mobile device is not compatible with the vehicle terminal having the most recent version software, some functions cannot be executed, or a fatal effect against a vehicle security or a driving safety can be incurred. Particularly, since updating the vehicle engagement application is dependent upon the user, it is difficult to properly and timely update the vehicle engagement application in order to maintain compatibility with software installed in vehicle terminal.

### SUMMARY

Embodiments of the disclosure are directed to a system, a method and an apparatus operable to, when the mobile device accesses to vehicle terminal, automatically check an upgrade notice about a vehicle engagement application installed in a mobile device engaged with the vehicle, which is capable of inducing an upgrade, or blocking execution, of the vehicle engagement application in response to a check result. Embodiments of the disclosure further provide a system, a method and an apparatus operable to continuously maintain compatibility between the most recent version software installed at a vehicle terminal and a vehicle engagement application installed at a mobile device in order to enhance driver's convenience, vehicle security, and driving safety.

In accordance with embodiments of the present disclosure, a method managing a vehicle engagement application performed at a vehicle terminal includes: establishing a data communication link with a mobile device; receiving a notification status corresponding to the vehicle engagement application via the data communication link, the notification status indicating whether the vehicle engagement application is up-to-date; and determining whether it is necessary to update the vehicle engagement application based on the notification status. A predetermined control signal for managing the vehicle engagement application is transmitted to the mobile device according to the determination.

The method can further include transmitting a notification status request message via the data communication link; and receiving a notification status answer message in response to the notification status request message.

The method may further include transmitting a predetermined popup request message for presenting a predetermined guidance message for inducing an upgrade of the vehicle engagement application on the mobile device when it is determined that it is necessary to update the vehicle engagement application.

The method may further include transmitting an execution request message for executing the vehicle engagement application into the mobile device when it is determined that it is unnecessary to update the vehicle engagement application.

The method may further include determining whether updating the vehicle engagement application is rejected or blocked when it is determined that it is necessary to update the vehicle engagement application; and transmitting an execution block request message for blocking execution of the vehicle engagement application in the mobile device when updating the vehicle engagement application is rejected or blocked.

The notification status may include a number of times which an update notice message corresponding to the vehicle engagement application has been received. The updating of the vehicle engagement application may be considered rejected when the number of times is greater than a predetermined number.

The notification status may include setup information regarding whether the updating the vehicle engagement application is blocked, which is set according to a menu selection on the mobile device. It may be determined whether the updating the vehicle engagement application is blocked based on the setup information.

The method may further include outputting a guidance message instructing that use of the vehicle engagement application is blocked on a screen when the updating the vehicle engagement application is blocked.

The notification status may include version information of the vehicle engagement application, and whether it is necessary to update the vehicle engagement application may be determined by comparing a software version of the vehicle terminal with the version information of the vehicle engagement application.

The method may further include: determining whether the vehicle engagement application is automatically updated when it is determined that it is necessary to update the vehicle engagement application; and transmitting an automatic application update request message for controlling the mobile device to automatically update the vehicle engagement application when the vehicle engagement application is automatically updated.

The method may further include transferring a predetermined popup request message for presenting a predetermined guidance message for inducing upgrade of the vehicle engagement application on the mobile device when it is determined that it is unnecessary to update the vehicle engagement application.

The notification status can include version information of the vehicle engagement application. Compatibility can be determined based on software version of the vehicle terminal with the version information of the vehicle engagement application. A control signal is transmitted for partially or totally blocking an execution of the vehicle engagement application in response to the determined compatibility is transmitted to the mobile device.

Furthermore, in accordance with embodiments of the present disclosure, a method performed at a mobile device for managing a vehicle engagement application installed at the mobile device includes: establishing a data communication link with a vehicle terminal; receiving a notification status request message from the vehicle terminal; collecting a notification status corresponding to the vehicle engagement application indicating whether the vehicle engagement application is up-to-date; transmitting a notification status answer message including the notification status to the vehicle terminal; and providing a predetermined message for informing that the vehicle engagement application should be updated when a popup request message is received from the vehicle terminal. The popup request message is transmitted to the mobile device when it is determined at the vehicle terminal that updating the vehicle engagement application is necessary.

The method may further include: receiving an execution request message for executing the vehicle engagement application when it is determined at the vehicle terminal that updating the vehicle engagement application is unnecessary; and executing the vehicle engagement application in response to the execution request message.

The method may further include receiving an execution block request message for blocking execution of the vehicle engagement application. The execution block request message may be transmitted to the mobile device when it is determined at the vehicle terminal that updating the vehicle engagement application is rejected or blocked.

The notification status may include a number of times which an update notice message corresponding to the vehicle engagement application has been received, and the updating of the vehicle engagement application may be considered rejected when the number of times is greater than a predetermined number.

The notification status may include setup information regarding whether the updating the vehicle engagement application is blocked, which is set according to a menu selection on the mobile device. It may be determined whether updating the vehicle engagement application is blocked based on the setup information.

A guidance message instructing that use of the vehicle engagement application is blocked may be shown on a screen of the mobile device when the execution block request message is transmitted to the mobile device.

The notification status may include version information of the vehicle engagement application, and whether it is necessary to update the vehicle engagement application may be determined by comparing a software version of the vehicle terminal with the version information of the vehicle engagement application.

The method can further include: receiving an automatic application update request message for instructing automatic update of the vehicle engagement application from the vehicle terminal; providing a predetermined guidance message for informing a progress of the automatic update; accessing a server for updating the vehicle engagement application to download a most recent version; and installing and executing the downloaded most recent version. The automatic application update request message may be transmitted to the mobile device when it is determined at the vehicle terminal that the updating of the vehicle engagement application is necessary and the automatic update is available.

Furthermore, according to embodiments of the present disclosure, a non-transitory computer readable medium stores a program causing a computer to manage a vehicle engagement application installed at a mobile device, the management process performed at a vehicle terminal. The management process includes: establishing a data communication link with a mobile device; receiving a notification status corresponding to the vehicle engagement application via the data communication link, the notification status indicating whether the vehicle engagement application is up-to-date; and determining whether it is necessary to update the vehicle engagement application based on the notification status. A predetermined control signal for managing the vehicle engagement application is transmitted to the mobile device according to the determination.

Furthermore, according to embodiments of the present disclosure, a vehicle terminal engaging with a mobile device for managing a vehicle engagement application installed in the mobile device includes: a communication unit establishing a data communication link with the mobile device; a notification status checking module receiving a notification status corresponding to the vehicle engagement application via the data communication link and determining whether it is necessary to update the vehicle engagement application based on the notification status, the notification status indicating whether the vehicle engagement application is up-to-date; and an installation inducing module generating a popup request message for inducing upgrade of the vehicle engagement application when it is determined to be necessary to update the vehicle engagement application, and transmitting the popup request message to the mobile device.

Furthermore, according to embodiments of the present disclosure, a mobile device engaging with a vehicle terminal includes: a communication unit establishing a data communication link with the vehicle terminal; a notification status informing module receiving a notification status request message from the vehicle terminal, collecting a notification status corresponding to a vehicle engagement application installed at the mobile device, and transmitting a notification status answer message including the notification status to the vehicle terminal, the notification status indicating whether the vehicle engagement application is up-to-date; and an output unit providing a predetermined popup window for informing that the vehicle engagement application should be updated when a popup request message is received from the vehicle terminal, wherein the popup request message is transmitted to the mobile device when it is determined at the vehicle terminal that updating the vehicle engagement application is necessary.

Furthermore, according to embodiments of the present disclosure, a system for managing a vehicle engagement application installed in a mobile device includes: a vehicle terminal configured to receive a notification status corresponding to the vehicle engagement application, to determine whether it is necessary to update the vehicle engagement application based on the notification status, and to transmit a popup request message to the mobile device based on the determination in order to induce upgrade of the vehicle engagement application, the notification status indicating whether the vehicle engagement application is up-to-date; and the mobile device configured to collect the notification status corresponding to the vehicle engagement application in response to a notification status request message received from the vehicle terminal, to transmit a notification status answer message including the notification status to the vehicle terminal, and to provide a predetermined guidance message and an application server URL address in order to inform that the vehicle engagement application should be updated when the popup request message is transmitted to the mobile device.

Advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 shows an application version management system;

FIG. 2 describes a vehicle terminal for executing a method for managing a vehicle engagement application;

FIG. 3 shows a mobile device for executing a method for managing a vehicle engagement application;

FIG. 4 shows an application installation checking process at the vehicle terminal engaging with the mobile device;

FIG. 5 shows an application deletion checking process at the vehicle terminal engaging with the mobile device;

FIG. 6 illustrates a method for managing a vehicle engagement application;

FIG. 7 illustrates a method for managing a vehicle engagement application;

FIG. 8 illustrates a method for managing a vehicle engagement application; and

FIG. 9 shows a mapping table used at the vehicle terminal for managing a vehicle engagement application.

### DETAILED DESCRIPTION OF THE EMBODIMENTS

Reference will now be made in detail to the embodiments of the disclosure, examples of which are illustrated in the accompanying drawings. In the drawings, the same elements are denoted by the same reference numerals, and a repeated explanation thereof will not be given. As those skilled in the art would realize, the described embodiments may be modified in various different ways, all without departing from the spirit or scope of the present disclosure.

The suffixes “module” and “unit” of elements herein are used for convenience of description and thus can be used interchangeably and do not have any distinguishable meanings or functions. The terms “a” or “an”, as used herein, are defined as one or more than one. The term “another”, as used herein, is defined as at least a second or more. The terms “including” and/or “having” as used herein, are defined as comprising (i.e., open transition). The term “coupled” or “operatively coupled” as used herein, is defined as connected, although not necessarily directly, and not necessarily mechanically.

Also, in the description of embodiments, terms such as first, second, A, B, (a), (b) or the like may be used herein when describing components of the present disclosure. Each of these terminologies is not used to define an essence, order or sequence of a corresponding component but used merely to distinguish the corresponding component from other component(s). It should be noted that if it is described in the specification that one component is “connected,” “coupled” or “joined” to another component, the former may be directly “connected,” “coupled,” and “joined” to the latter or “connected”, “coupled”, and “joined” to the latter via another component.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Furthermore, the controller of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

In the description of the disclosure, certain detailed explanations of related art are omitted when it is deemed that they may unnecessarily obscure the essence of the disclosure. The features of the disclosure will be more clearly understood from the accompanying drawings and should not be limited by the accompanying drawings. It is to be appreciated that all changes, equivalents, and substitutes that do not depart from the spirit and technical scope of the present disclosure are encompassed in the disclosure.

Hereinafter, with accompanying drawings, a method and an apparatus for controlling, and managing, vehicle engagement application configured to make arrangement between a vehicle terminal and a mobile device.

The mobile device, i.e., a portable terminal, can be realized as various types of mobile apparatuses. For the way of example but not limitation, the mobile device can be realized as at least one of a smartphone, a tablet personal computer (PC), a smart watch, smart glasses, a portable multimedia player (PMP), an MP3 player, a personal digital assistant (PDA), a cellphone, laptop computer, a smart TV, and other mobile terminal apparatuses. Further, some embodiments, if not relating to movable or portable function or circumstance, can be applicable to a digital TV, a desktop computer, and so on.

FIG. 1 shows an application version management system.

As shown in FIG. 1, the application version management system can include a vehicle terminal 10 configured to collect vehicle data and a mobile device 20 engaged with the vehicle terminal 10. The vehicle data can contain a mileage, a self-diagnosis data, an operation data and etc. according to a driving operation. If receiving the collected vehicle data from the vehicle terminal 10 throughout a predetermined wired or wireless data communication method 15, the mobile device can transfer the vehicle data into a service server included in a control center 30 via a predetermined wireless communication method 25 such as Wideband Code Division Multiple Access (WCDMA), Long Term Evolution (LTE), LTE-Advanced, Wi-Fi, Wimax, Wibro, or the like. The mobile device 20 receives plural information and management services provided from the service server at the control center 30 to thereby provide the plural information and management services to the vehicle terminal 10.

If software installed at the vehicle terminal 10 engages with a vehicle engagement application installed at the mobile device 20, a user who owns the mobile device 20 can check plural vehicle data throughout the vehicle engagement application, and control a particular function of vehicle. For example, the user, who operates the mobile device 20 by selecting a predetermined option provided on the vehicle engagement application, can execute function of vehicle multimedia play, air conditioner, a navigation device, a door lock, an ignition, a light control or the like. Further, the user, who operates the mobile device 20 by selecting a predetermined option provided on the vehicle engagement application, can check plural vehicle data collected by the vehicle terminal, such as information of driving speed, fuel state, tire inflation pressure, driving mileage, and etc.

As the wired or wireless data communication method 15 between the vehicle terminal 10 and the mobile terminal 20, any one of an USB cable, Bluetooth, RF, Wi-Fi, ZigBee, Near Field Communication (NFC) can be available.

Additionally, the vehicle terminal 10 can wirelessly communicate with the control center 30, e.g., a telematics sever, without the mobile device 20. Further, the vehicle terminal 10 can include a Global Positioning System (GPS) module for obtaining location information, and receive a signal transmitted from a global positioning satellite to acquire the location information.

Particularly, the vehicle terminal 10, if engaging with the mobile device 20, can transmit a notification status request message for obtaining a notification status corresponding to the vehicle engagement application installed at the mobile device 20 so as to check reception state of a notification message for informing update of the vehicle engagement application. Herein, the notification status of vehicle engagement application can include information of the reception state of the notification message for instructing that the corresponding vehicle engagement application should be updated, detailed statement of notification message, and so on. For example, the detailed statement of notification message can include at least one of information for indicating whether the corresponding update is mandatory for normal engagement with software installed at the vehicle terminal 10, what is a compatible software version of the vehicle terminal 10, when the vehicle engagement application is (previously) updated, and how many times an update notice message corresponding to the vehicle engagement application is received.

Based on the notification status received from the mobile device 20, the vehicle terminal 10 can transmit to the mobile device 20 a predetermined popup request message for inducing upgrade of the vehicle engagement application on the mobile device. By the way of example but not limitation, the popup request message can include a predetermined guidance message shown in a popup window. If the popup request message is delivered, the mobile device 20 can present, on a screen, a predetermined guidance message for upgrade of the vehicle engagement application as well as an application server URL address for accessing to a corresponding application server 40. For example, the popup window for inducing upgrade of the vehicle engagement application can include a character string of guidance such as “New function is available. Please, update application and enjoy new function.”, and an access link including a URL address for downloading the upgrade of vehicle engagement application.

Herein, communication between the mobile device 20 and the application server 40 can be performed via a wireless technology such as Wideband Code Division Multiple Access (WCDMA), Long Term Evolution (LTE), LTE-Advanced, Wi-Fi, Wimax, Wibro, or the like.

As another example, if determining that update of the vehicle engagement application is necessary based on the notification status provided from the mobile device 20, the vehicle terminal 10 can transfer a predetermined automatic application update request message without an additional popup request message to the mobile device 20.

When receiving the automatic application update request message, the mobile device 20 can access to a service server, an application store or the control center 30 and start an update progress of the corresponding vehicle engagement application after downloading the requested vehicle engagement application from the application server 40. By the way of example but not limitation, upgrading the vehicle engagement application according to the automatic application update request message can be performed without additional user's authorization process. For another example, if the automatic application update request message is delivered, the mobile device 20 can begin user's authorization process for updating the vehicle engagement application with a predetermined guidance message, which indicates that the corresponding vehicle engagement application should be updated.

In addition, the vehicle terminal 10 can determine whether updating the vehicle engagement application is necessary, referring to the notification status and a software mapping table previously stored. Further, the vehicle terminal 10 can check compatibility based on a software version of the vehicle terminal 10 and a version of the vehicle engagement application, and as compatibility result, transmit to the mobile device 20 a predetermined control signal for blocking a total execution, or a partial function, of the vehicle engagement application.

As another example, the vehicle terminal 10 can communicate with the application server 40. In this case, the vehicle terminal 10 accesses to the application server 40 to obtain information about the last version corresponding to a vehicle engagement application. The vehicle terminal 10 can compare the version of vehicle engagement application installed in the mobile device 20 with the last version of the corresponding vehicle engagement application to thereby determine whether updating the vehicle engagement application is necessary.

If a data communication link with the vehicle terminal 10 is established, the mobile device 20 can access to the application server 40 to obtain the last version of corresponding vehicle engagement application installed in the mobile device 20, and compare the presently installed version with the last version to thereby determine whether updating the vehicle engagement application is necessary.

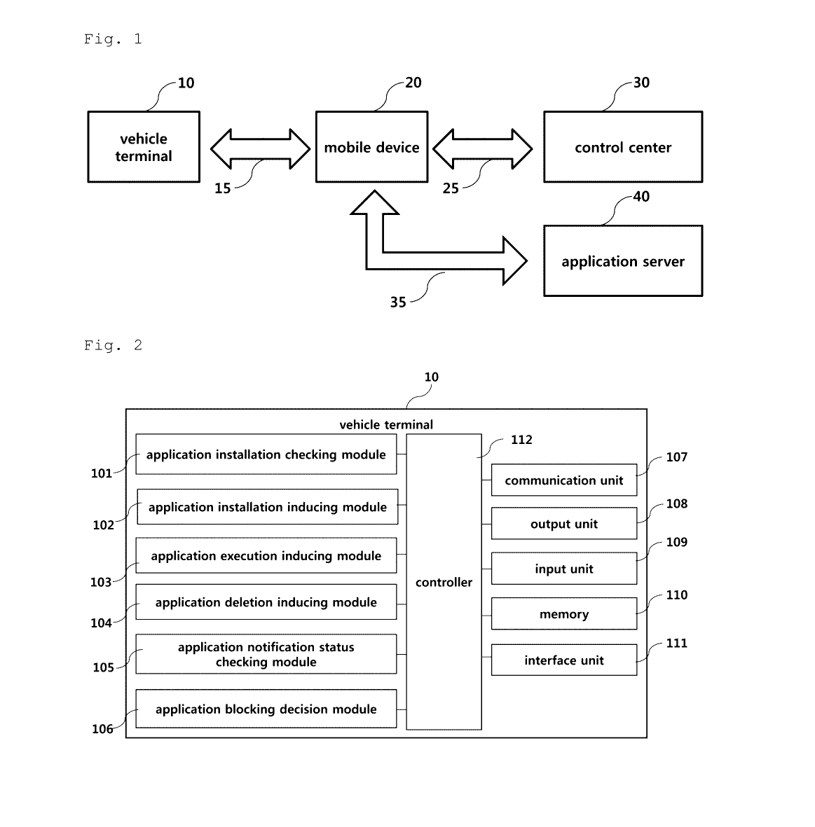

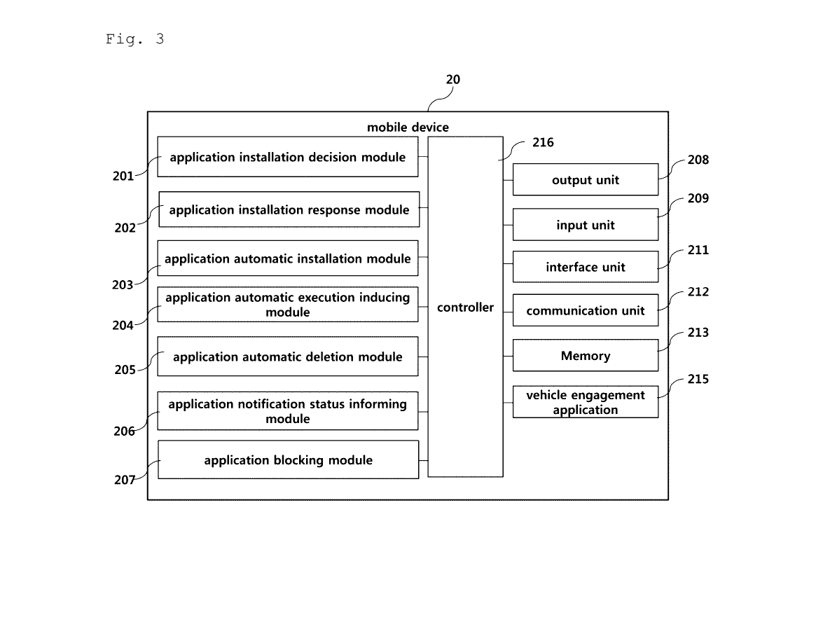

FIG. 2 describes a vehicle terminal for executing a method for managing a vehicle engagement application.

As shown in FIG. 2, the vehicle terminal 10 can include an application installation checking module 101, an application installation inducing module 102, an application execution inducing module 103, an application deletion inducing module 104, an application notification status checking module 105, an application blocking decision module 106, a communication unit 107, an output unit 108, an input unit 109, a memory 110, an interface unit 111 and a controller 112. The components of vehicle terminal 10 can be not mandatory, so the vehicle terminal 10 can include more or less components than that shown in FIG. 2.

The controller 112 can control overall operation of vehicle terminal 10, and deliver signals received from an internal module or an external device to other modules or control other modules to transmit a signal delivered from the other modules to an external device such as the mobile device 20, the control center 30 or the like.

The communication unit 107 can provide a data communication method for communicating with the mobile device 20. Further, the communication unit 107 can further include a wireless communication method 25 for performing a direct wireless communication with the control center 30. For another example, the vehicle terminal 10 can use a mobile communication module to access to a service server providing a vehicle engagement application, e.g., a Google application store, an Apple application store, an Android market, or etc., and download the vehicle engagement application from the service server via the mobile communication module. Then, the vehicle terminal 10 can transfer the downloaded vehicle engagement application to the coupled mobile device 20.

The output unit 108 is for generating an output relating to sight, hearing, touch, or etc., which can include a display module, an audio output module, an alarm module, a haptic, and/or the like.

The display module can present information processed in the vehicle terminal 10. For an example, in a mode of hands-free phone, the display module can show a User Interface (UI) or a Graphic User Interface (GUI) relating to a phone call. The display module can include at least one of a Liquid Crystal Display (LCD), a Thin Film Transistor-LCD (TFT-LCD), an Organic Light Emitting Diode (OLED) display, a flexible display, a three-dimensional (3D) display, or the like.

The audio output module can output an audio data received from the communication unit 107 or stored in the memory 110 in a call signal reception mode, a call mode, a record mode, a voice recognition mode, a Bluetooth pairing mode, and the like. The audio output module can include a speaker, a buzzer, or other sound generating device. Further, the audio output module 362 can output an audio data via an earphone jack located at one side of the vehicle.

The alarm module can provide outputs to inform about the occurrence of an event of the vehicle terminal 10. Typical events can include call reception, message reception, key signal inputs, a touch input, a connection with the mobile device 20, and etc.

The haptic module can generates various tactile effects the user may feel. A typical example of the tactile effects generated by the haptic module is vibration. The strength, pattern, and the like, of the vibration generated by the haptic module can be controlled by a predetermined user interface.

The input unit 109 can include a camera and a microphone for audio/video signal input and a key pad, a dome switch, a touch pad (e.g., a touch sensitive member that detects changes in resistance, pressure, capacitance, etc. due to being contacted), a jog wheel, a jog switch, and the like, which handles input data for use in operation control.

The memory 110 can store a program for operations of the controller 112, and temporarily store input/output data, e.g., phonebook, message, image, video, application program, or etc. Herein, the application program can include software engaged with the vehicle engagement application. The memory 110 can include at least one type of memories or recoding medium including a flash memory, a hard disk, a solid state disk (SSD), a silicon disk drive (SDD), a multimedia card (MMC), a multimedia micro card, a Secure Digital (SD) card, an xD-Picture Card, a random access memory (RAM), a static random access memory (SRAM), a read-only memory (ROM), an electrically erasable programmable read-only memory (EEPROM), a programmable read-only memory (PROM), a magnetic memory, a magnetic disc, an optical disc, and so on.

The interface unit 111 provides an interface for connecting the vehicle terminal 10 to all of external devices. The interface unit 111 receives data or power from an external device to deliver the data or the power into each of components inside the vehicle terminal 10, or transmits data internally collected to an external device. For example, the interface unit 111 can include a wired/wireless headset port, an external charger port, a memory card port, a port for connection with an identification module, an audio input/output (I/O) port, a video input/output (I/O) port, an earphone port, or the like.

The application installation checking module 101 can transmit, to the coupled mobile device 20, an application installation confirmation request message for checking whether the vehicle engagement application communicating with the vehicle terminal 10 is installed, and receive a response message, delivered from the mobile device 20, for informing whether the vehicle engagement application is installed.

The application installation inducing module 102, in response to information provided from the application installation checking module 101, can transmit to the mobile device 20 a control signal for inducing an installation of vehicle engagement application when a vehicle engagement application supporting the communication between the mobile device 20 and the vehicle terminal 10 is not installed at the mobile device 20.

Further, according to a result of determining whether updating the vehicle engagement application is necessary at the application notification status checking module 105, the application installation inducing module 102 can perform to transmit a predetermined popup request message for inducing upgrade of the vehicle engagement application to the mobile device 20 if upgrading the vehicle engagement application is necessary. At this time, if receiving the popup request message, the mobile device 20 can generate a popup window containing a predetermined guidance message for indicating that upgrade of the vehicle engagement application is necessary as well as an application server URL address for accessing to, downloading from, a corresponding application server the last version of vehicle engagement application.

The application execution inducing module 103, based on information provided from the application installation checking module 101, can transmit an execution request message for executing the vehicle engagement application into the mobile device 20 when the vehicle engagement application supporting the communication between the mobile device 20 and the vehicle terminal 10 is installed at the mobile device 20.

Further, based on a result of determining at the application notification status checking module 105 that updating the vehicle engagement application is not necessary, the application execution inducing module 103 can transmit an execution request message for executing the vehicle engagement application into the mobile device 20.

The application deletion inducing module 104 can determine whether the vehicle engagement application supporting the communication between the mobile device 20 and the vehicle terminal 10 is installed, based on the information provided from the application installation checking module 101. If it is determined that the corresponding vehicle engagement application should be deleted, the application deletion inducing module 104 can transmit a predetermined control signal for requesting automatic deletion into the mobile device 20.

For example, the application deletion inducing module 104 can transmit the control signal for requesting automatic deletion into the coupled mobile device 20 when the mobile device 20 includes a particular vehicle engagement application which can be influenced by a driving regulation, can be collided when engaging with the vehicle terminal 10, or cannot support update progress throughout patch data/files.

The application notification status checking module 105, if connection for communication with the mobile device 20 is successfully complete, can transmit to the mobile device 20 a predetermined notification status request message for obtaining a notification status corresponding to the vehicle engagement application installed at the mobile device 20 so as to check the notification status about present upgrade or download of the vehicle engagement application. Herein, the notification status can include information of the reception state of the notification message for instructing that the corresponding vehicle engagement application should be updated, detailed statement of notification message, and so on. For example, the detailed statement of notification message can include at least one of information for informing whether the corresponding update is mandatory for normal engagement with software installed at the vehicle terminal 10, what is a compatible software version of the vehicle terminal 10, when the vehicle engagement application is updated (i.e., has previously been updated), and how many times an update notice message corresponding to the vehicle engagement application has been received.

As described above, the application installation inducing module 102 transmits the popup request message to the mobile device 20. However, for another example, the application notification status checking module 105 can transfer to the mobile device 20 a predetermined popup request message for inducing a user to update the vehicle engagement application. Herein, the popup request message can include a predetermined guidance message shown in a popup window. For example, the guidance message for inducing upgrade of the vehicle engagement application can include a character string of guidance such as “New function is available. Please, update application and enjoy new function.”, and an access link including a URL address for downloading the upgrade of vehicle engagement application. For another example, if receiving the popup request message, the mobile device 20 can present, on a screen, a predetermined guidance message for upgrade of the vehicle engagement application as well as an application server URL address of corresponding application server.

In this case, the application notification status checking module 105 can transmit the popup request message to the mobile device 20 only if updating the corresponding vehicle engagement application is not mandatory.

In addition, based on the notification status delivered from the mobile device 20, the application notification status checking module 105 can transmit to the mobile device 20 a predetermined automatic application upgrade request message for automatically updating the vehicle engagement application without an additional popup window or user's input.

If the automatic application upgrade request message is delivered, the mobile device 20 can, without showing an additional popup notice window, access to a service server, an application store, or the control center 20 to download the vehicle engagement application which automatic update is requested and perform a progress of update. However, before or after downloading the vehicle engagement application which automatic update is requested, the application notification status checking module 105 can additionally perform user's confirmation process for updating the vehicle engagement application.

The application blocking decision module 106 can compare version information of software installed in the vehicle terminal 10 with version information of vehicle engagement application installed at the mobile device 20 to thereby block a particular function which is not available throughout the vehicle engagement application. For example, in order to block a particular function of vehicle control, the vehicle terminal 10 can transmit to the mobile device 20 an application block request message containing blocked function identification information corresponding to the particular function of vehicle control, which would be blocked to execute. If the application block request message is delivered, in response to the received blocked function identification information, the mobile device 20 can block a user to execute a disabled function on the executed vehicle engagement application. For example, blocking a particular function can be achieved by disabling a menu corresponding to the blocked function on the vehicle engagement application, i.e., showing that the corresponding menu/option is not selectable.

As another example, in order to block a particular function of vehicle control, the vehicle terminal 10 does not transmit the application block request message to the mobile device 20, and just ignore a case when a predetermined request message corresponding to the disabled function is delivered from the mobile device 20.

As another example, after comparing version information of software installed in the vehicle terminal 10 with version information of vehicle engagement application installed at the mobile device 20, the application blocking decision module 106 can transmit to the mobile device 20 an execution block request message for totally blocking execution of vehicle engagement application if it is determined that the execution of vehicle engagement application can be critical against a vehicle security and a driving safety. If the execution block request message is delivered, the mobile device 20 can block the execution of corresponding vehicle engagement application by a user. If the blocked vehicle engagement application is selected by the user, the mobile device 20 can show a popup guidance window indicating that the vehicle engagement application cannot execute, before the vehicle engagement application is completely upgraded.

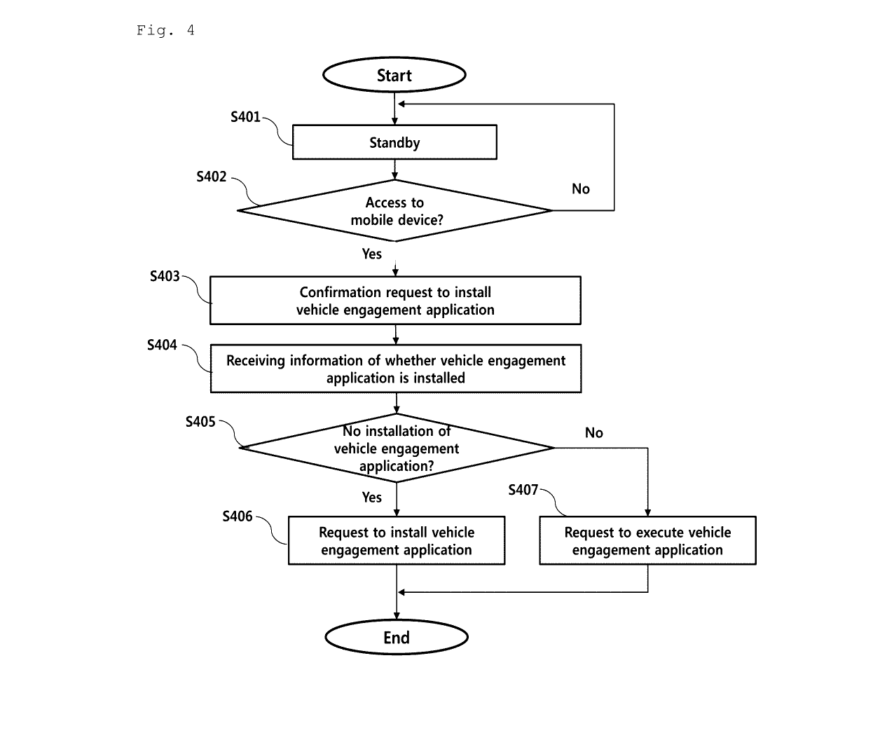

FIG. 3 shows a mobile device for executing a method for managing a vehicle engagement application.

As shown in FIG. 3, the mobile device can include an application installation decision module 201, an application installation response module 202, an application automatic installation module 203, an application automatic execution inducing module 204, an application automatic deletion module 205, an application notification status informing module 206, an application blocking module 207, an output unit 208, an input unit 209, an interface unit 211, a communication unit 212, a memory 213, a vehicle engagement application 215, and a controller 216. The components of mobile device 20 can be not mandatory, so the mobile device 20 can include more or less components than that shown in FIG. 3.

The controller 216 can control overall operation of mobile device 20, deliver signals received from an internal module or an external device to other modules or control other modules, and control the communication unit 212 to transmit a signal delivered from the other modules into an external device such as the vehicle 10, the control center 30 or the like.

The communication unit 212 can provide a data communication method 15 for communicating with the vehicle terminal 10. Further, the communication unit 212 can further include a wireless communication method 25 for performing a wireless communication with the control center 30. For another example, the communication unit 212 can include a mobile communication module. In this case, the vehicle terminal 10 can use the mobile communication module to access to a service server providing a vehicle engagement application, e.g., a google application store, an apple application store, an android market, or etc., and download the vehicle engagement application from the service server via the mobile communication module. Then, the mobile device 20 can store the downloaded vehicle engagement application in the memory 213 and install the downloaded vehicle engagement application.

The output unit 208 is for generating an output relating to sight, hearing, touch, or etc., which can include a display module, an audio output module, an alarm module, a haptic, and/or the like. Herein, the display module, the audio output module, the alarm module, and the haptic module can be same with, or similar to, those included in the vehicle terminal 10.

For example, if receiving a predetermined update notice message informing that there is update of vehicle engagement application, which is delivered from the service server or the control center 30, the output unit 208 can display a reception state of notification message in an area of notification bar on a display screen according to a control signal. Herein, the receptions state of notification message can be displayed by an icon or an image, which is distinguishable from each other in response to a kind of notification message, or the number of times which an update notice message corresponding to the vehicle engagement application is received. The reception state of notification message can be recorded in a message box.

As another example, when the output unit 208 receives a predetermined update notice message informing that there is update of vehicle engagement application and when it is determined that the vehicle engagement application corresponding to the update notice message should be updated, the output unit 208 can display a popup window containing a predetermined guidance message for indicating that the vehicle engagement application should be updated as well as an application server URL address for accessing to, downloading from, a corresponding application server the last version of vehicle engagement application, in response to a control signal delivered from the controller 216.

In addition, the controller 216 can make a window informing a progress of installing the vehicle engagement application 215 and an execution of the vehicle engagement application 215, and output the window throughout the output unit 208.

The application installation decision module 201, according to a confirmation request to install a vehicle engagement application, which is delivered from the engaged vehicle terminal 10, can check whether the vehicle engagement application is installed on an operating system, and provide a checked result to the application installation response module 202.

The application installation response module 202 can provide the checked result of whether the vehicle engagement application is installed on an operating system to the vehicle terminal 10 via the controller 216 and the communication unit 212.

The application automatic installation module 203, in response to a request for installing vehicle engagement application, which is delivered from the engaged vehicle terminal 10, can access, throughout the communication unit 212, to a service server (herein, the service server can include an application server such as a Google Apps store, Apple Apps store, Android market, or the like), and search the vehicle engagement application corresponding to a software installed at the vehicle terminal 10 in order to perform an automatic installation procedure.

The application automatic execution inducing module 204 can execute the installed vehicle engagement application based upon a request for automatically executing a vehicle engagement application, which is delivered from the engaged vehicle terminal 10.

The application automatic deletion module 205, according to a request for deleting a vehicle engagement application, which is delivered from the engaged vehicle terminal 10, can perform a function of deleting an installed vehicle engagement application.

Further, the application automatic deletion module 205 can perform a function of automatically deleting a vehicle engagement application which can affect driving safety or driving regulation violation, should be deleted for updating a vehicle engagement application, or can conflict on the engagement with the vehicle terminal 10.

The application notification status informing module 206, if receiving, from the engaged vehicle terminal 10, a predetermined notification status request message for obtaining a notification status corresponding to the vehicle engagement application installed at the mobile device 20, can generate a notification status answer message including the notification status to thereby provide the notification status answer message to the vehicle terminal 10.

Herein, the notification status can include information of the reception state of the notification message for instructing that the corresponding vehicle engagement application should be updated, detailed statement of notification message, and so on. For example, the detailed statement of notification message can include at least one of information for indicating whether the corresponding update is mandatory for normal engagement with software installed at the vehicle terminal 10, what is a compatible software version of the vehicle terminal 10, when the vehicle engagement application is updated, and how many times an update notice message corresponding to the vehicle engagement application is received.

The application blocking module 207, when receiving an application block request message from the vehicle terminal 10, can perform a function of blocking the corresponding function or the corresponding vehicle engagement application. Herein, the application block request message can contain identification information of blocked function which would be blocked to execute.

The memory 213 can store a program for operations of the controller 216, and temporarily store an input/output data, e.g., phonebook, message, image, video, application program, or etc. Herein, the application program can include a vehicle engagement application engaged with software installed at the vehicle terminal 10. The memory 213 can include at least one type of memories or recoding medium including a flash memory, a hard disk, a solid state disk (SSD), a silicon disk drive (SDD), a multimedia card (MMC), a multimedia micro card, a Secure Digital (SD) card, an xD-Picture Card, a random access memory (RAM), a static random access memory (SRAM), a read-only memory (ROM), an electrically erasable programmable read-only memory (EEPROM), a programmable read-only memory (PROM), a magnetic memory, a magnetic disc, an optical disc, and so on.

The interface unit 211 provides an interface for connecting the mobile device 20 to all of external devices. The interface unit 211 receives data or power from an external device to deliver the data or the power into each of components inside the mobile device 20, or transmits data internally collected to an external device. For example, the interface unit 211 can include a wired/wireless headset port, an external charger port, a memory card port, a port for connection with an identification module, an audio input/output (I/O) port, a video input/output (I/O) port, an earphone port, or the like.

The vehicle engagement application 215, which is a kind of particular application software which engages with the vehicle terminal 10 and performs transmission and reception of data or plural control signals, can be downloaded and installed to run on an operating system in the mobile device 20. Herein, the operating system can include one of i-OS, Android OS, MS Window OS, MAC OS, Linux OS, Sun OS, and etc.

Hereinafter, detailed processes executed by embodiments including functions above described are described.

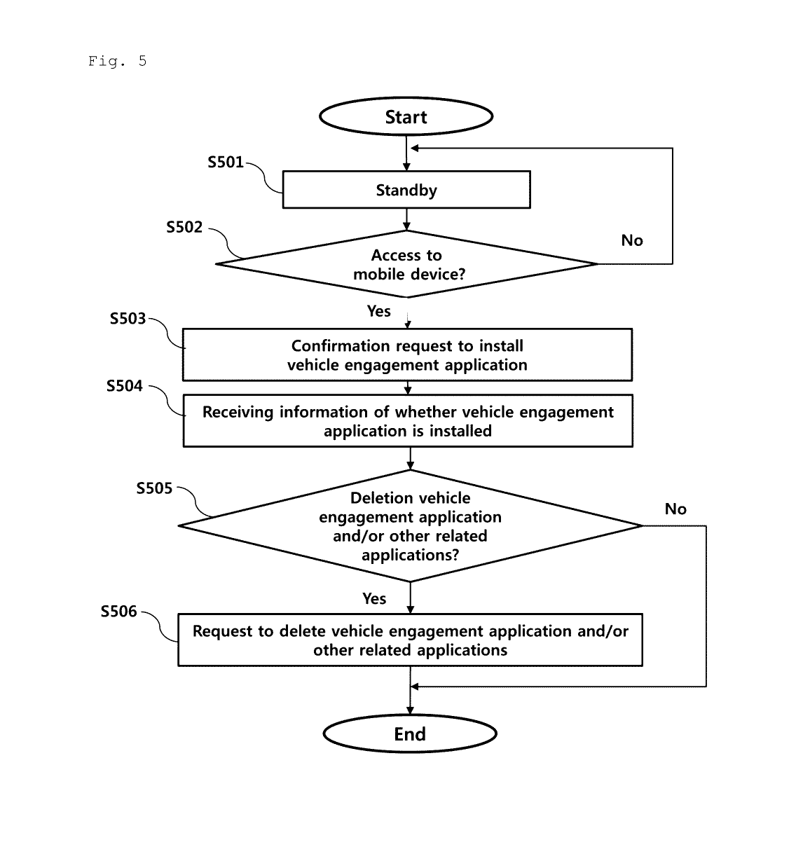

FIG. 4 shows an application installation checking process at the vehicle terminal engaging with the mobile device.

As shown in FIG. 4, from a standby S401, the vehicle terminal 10 determines whether the mobile device 20 is arranged for data communication (S402).

For the arrangement between the vehicle terminal 10 and the mobile device 20, one of a wired connection using an USB cable and a wireless connection such as a Bluetooth communication, a RF communication, a Wi-Fi communication, a ZigBee communication, and an NFC communication can be used.

If it is determined at the step S402 that the mobile device 20 is engaged, the vehicle terminal 10 can activate the application installation checking module 101 so as to transmit a confirmation request about whether the vehicle engagement application 215 is installed at the mobile device 20 (S403).

Within a predetermined time, the vehicle terminal 10 can receive information about whether the vehicle engagement application 215 is installed at the mobile device 20 (S404).

The application installation checking module 101 in the vehicle terminal 10 analyzes the information delivered from the mobile device 20 to thereby determine whether the vehicle engagement application 215 is installed at the mobile device 20 (S405).

In a case when the vehicle engaged application 215 is not installed at the mobile device 20, which is determined in the step S405, the vehicle terminal 10 can enable the application installation inducing module 102 in order to transmit to the mobile device 20 a request to install the vehicle engagement application 215 (S406).

Accordingly, at the mobile device 20, the vehicle engagement application 215 which is capable of engaging with the vehicle terminal 10 can be downloaded from an application store or an Android market and installed.

If the vehicle engaged application 215 is installed at the mobile device 20, which is determined in the step S405, the vehicle terminal 10 can enable the application execution inducing module 103 to thereby transmit a request for running the vehicle engagement application 215 to the mobile device 20.

Accordingly, the mobile device 20 can execute and activate the vehicle engagement application 215.

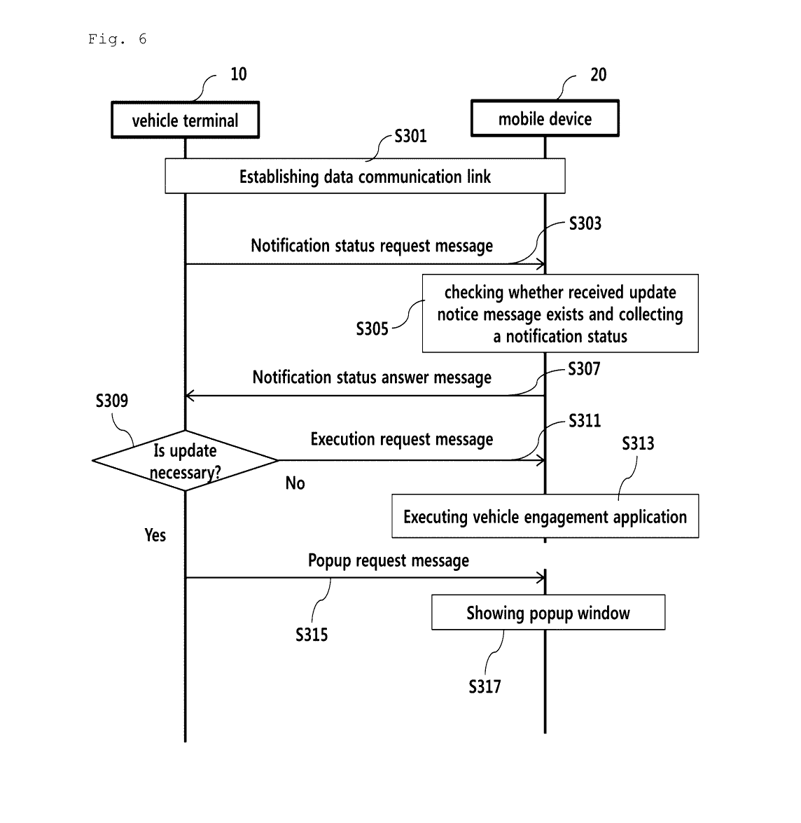

FIG. 5 shows an application deletion checking process at the vehicle terminal engaging with the mobile device.

As shown in FIG. 5, from a standby S501, the vehicle terminal 10 determines whether the mobile device 20 is arranged for data communication (S502).

For the arrangement between the vehicle terminal 10 and the mobile device 20, one of a wired connection using an USB cable and a wireless connection such as a Bluetooth communication, a RF communication, a Wi-Fi communication, a ZigBee communication, and an NFC communication can be used.

If it is determined at the step S502 that the mobile device 20 is engaged, the vehicle terminal 10 can activate the application installation checking module 101 so as to transmit a confirmation request about whether the vehicle engagement application 215 is installed at the mobile device 20 (S503).

Within a predetermined time, the vehicle terminal 10 can receive information about whether the vehicle engagement application 215 is installed at the mobile device 20 (S504).

The vehicle terminal 10 can determine whether it is required to delete the vehicle engagement application 215 installed at the mobile device 20 or a particular application which can affect driving safety or driving regulation violation, should be deleted for updating a vehicle engagement application, can be incapable of patch application, or can conflict on the engagement with the vehicle terminal 10 (S505).

If the vehicle terminal 10 finds an application which should be deleted, the vehicle terminal 10 can enable the application deletion inducing module 104 to transmit a request to delete the vehicle engagement application 215 and/or other particular applications into the mobile device 20 (S406).

Accordingly, the vehicle terminal 10 can control a function of automatically deleting the vehicle engagement application 215 installed at the mobile device 20, another particular vehicle engagement application affecting a driving regulation violation, another vehicle engagement application which should be deleted for updating a vehicle engagement application, or another vehicle engagement application which can conflict on the engagement with the vehicle terminal 10.

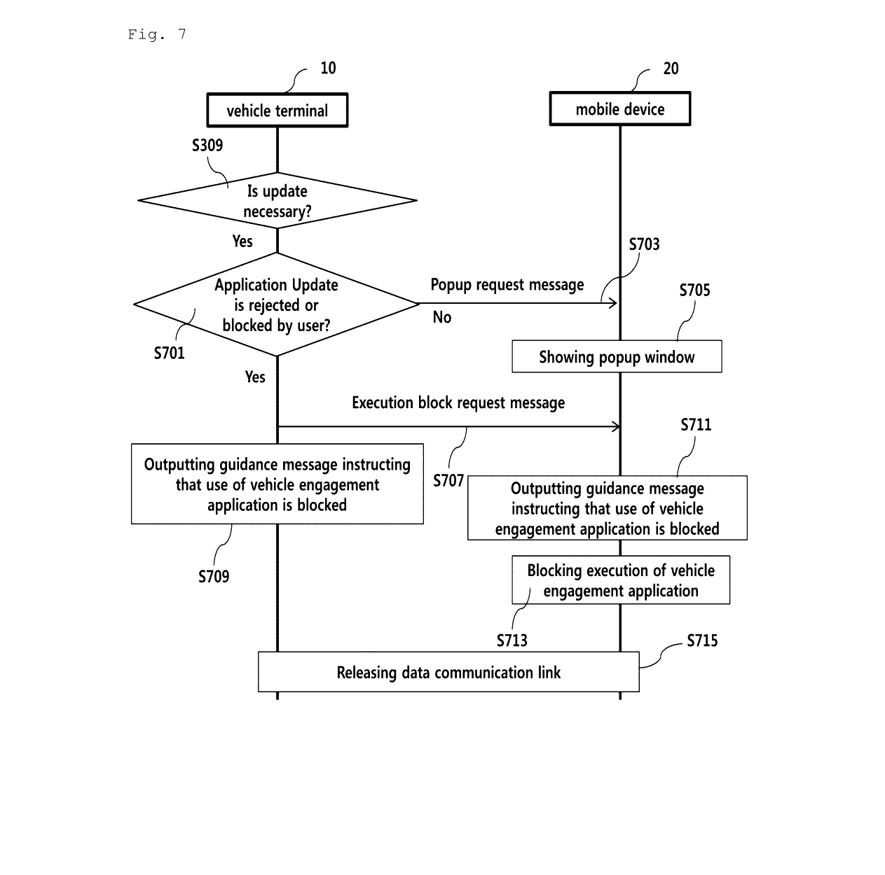

FIG. 6 illustrates a method for managing a vehicle engagement application.

As shown in FIG. 6, if a data communication link between the vehicle terminal 10 and the mobile device 20 is successfully established, the vehicle terminal 10 can transmit a notification status request message, which is for checking whether a predetermined notification message about updating, downloading, or upgrading the vehicle engagement application, into the mobile device 20 (S301 to S303). Herein, the notification message can include a warning message for encouraging a user to install the last version of vehicle engagement application, which is downloaded and stored in the mobile device 20.

The mobile device 20, if receiving the notification status request message, can check whether there is a notification message for updating, downloading, or upgrading the vehicle engagement application, which is corresponding to the installed the vehicle engagement application (S305). Further, the mobile device 20 can collect notification status information when there is a received upgrading notification message corresponding to the vehicle engagement application.

The mobile device 20 can transmit a notification status answer message, which contains notification status information collected based on a checked result in the step S305, into the vehicle terminal 10 (S307). Herein, the notification status information include at least one of information of the reception state of the notification message, application identification information for recognizing the vehicle engagement application corresponding to the received notification message, version information of the vehicle engagement application installed at the mobile device 20, which should be updated, corresponding to the notification message, the last version information of the vehicle engagement application which should be updated, and the number of times which an update notice message corresponding to the vehicle engagement application is received. If there are plural vehicle engagement applications installed at the mobile device 20, the mobile device 20 can transmit a notification status answer message, which includes notification status information about each vehicle engagement application, into the vehicle terminal 10.

When there is a vehicle engagement application matched with a notification message for indicating that updating the vehicle engagement application is required based on the received notification status answer message, the vehicle terminal 10 can compare the version of software currently installed at the mobile device 20 with the version of software at the vehicle terminal 10 engaged with the vehicle engagement application to thereby determine whether the corresponding vehicle engagement application should be updated (S309). At this time, the vehicle terminal 10 can include a software mapping table, shown in following FIG. 9, which is used for determining whether updating the vehicle engagement application is required. For example, the software mapping table can define version information of vehicle engagement application which is completely compatible with version of software installed at the vehicle terminal 10. Further, the software mapping table can define version information of vehicle engagement application which is not completely compatible with version of software installed at the vehicle terminal 10. In addition, the software mapping table can define version information of vehicle engagement application which is partially compatible with version of software installed at the vehicle terminal 10.

If updating the vehicle engagement application is required based on a determination result in the step S309, the vehicle terminal 10 can transmit a predetermined popup request message to the mobile device 20 (S315). For example, when the vehicle engagement application currently installed at the mobile device 20 is not totally or partially compatible with the software installed in the vehicle terminal 10, the vehicle terminal 10 can the popup request message to the mobile device 20. For another example, the vehicle terminal 10 can transmit the popup request message to the mobile device 20 when the number of times, which an update notice message corresponding to the vehicle engagement application is received, is beyond a predetermined number.

When receiving the popup request message, the mobile device 20 can generate a popup window containing a predetermined guidance message for indicating upgrading of the vehicle engagement application is required as well as an application server URL address for accessing to corresponding application server, and display the popup window on a screen (S317). At this time, a user having the mobile device 20 can read a message in the popup window, and select the URL address for update. If the URL address for update is selected, the mobile device 20 can access to the application server corresponding to the URL address, download the last version of software, and automatically install and run the downloaded version of software. Then, the mobile device 20 can use the newly installed vehicle engagement application to engage with the vehicle terminal 10.

If updating the vehicle engaged application is not required, which is determined in the step S309, the vehicle terminal 10 can transmit an execution request message for executing the corresponding vehicle engagement application into the mobile device 20 (S311).

If the execution request message is delivered, the mobile device 20 can run the corresponding vehicle engagement application (S313).

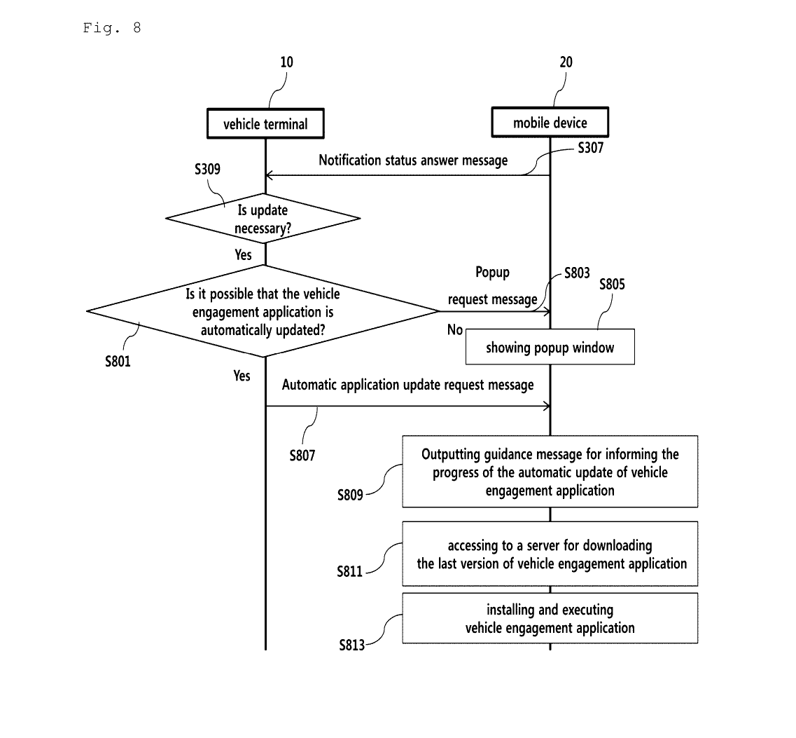

FIG. 7 illustrates a method for managing a vehicle engagement application.

As shown in FIG. 7, if updating the vehicle engagement application is necessary at the step S309 shown in FIG. 6, the vehicle terminal 10 can determine whether updating the corresponding vehicle engagement application is rejected or blocked by a user having the mobile device 20 (S701). For example, the vehicle terminal 10 can determine that the user having the mobile device 20 rejects updating the vehicle engagement application, when the number of times, which an update notice message corresponding to the vehicle engagement application is received, is beyond a predetermined number. For another example, if the user blocks update of vehicle engagement application throughout setting options on a menu provided by the mobile device 20 or the vehicle terminal 10, the vehicle terminal 10 can determine updating the vehicle engagement application is blocked. For the way of example but not limitation, the vehicle terminal 10 can receive the selected option about whether updating the vehicle engagement application is blocked throughout the notification status answer message described in FIG. 6.

When, in the step S701, updating the vehicle engagement application is rejected or blocked, the vehicle terminal 10 can transmit an execution block request message for blocking execution of the vehicle engagement application into the mobile device 20 (S707). At this time, at least one of the vehicle terminal 10 and the mobile device 20 can output a predetermined guidance message, instructing that use of the vehicle engagement application is blocked, on a screen (S709, S710, S711).

When updating the vehicle engagement application is rejected or blocked, the vehicle terminal 10 can determine whether the version of vehicle engagement application installed at the mobile device 20 is compatible with a version of software installed at the vehicle terminal 10. If the determination result says that the vehicle engagement application installed at the mobile device 20 is not totally compatible with the software installed at the vehicle terminal 10, the vehicle terminal 10 can transmit a control signal for blocking execution of the vehicle engagement application into the mobile device 20. Further, if the vehicle engagement application installed at the mobile device 20 is partially compatible with the software installed at the vehicle terminal 10, the vehicle terminal 10 can transmit a control signal for partially blocking an incompatible function of the vehicle engagement application into the mobile device 20.

The mobile device 20, receiving an execution block request message, can block an execution of corresponding vehicle engagement application and release the established data communication link (S713, S714, S715).

When updating the vehicle engagement application is not rejected nor blocked according to the determination result in the step S701, the vehicle terminal 10 can transmit a predetermined popup request message to the mobile device 20. Then, the mobile device 20, receiving the popup request message, can generate a popup window including both a predetermined guidance message for indicating that there is upgrade of the vehicle engagement application and an application server URL address for accessing to a corresponding application server, and display the popup window on a screen (S705).

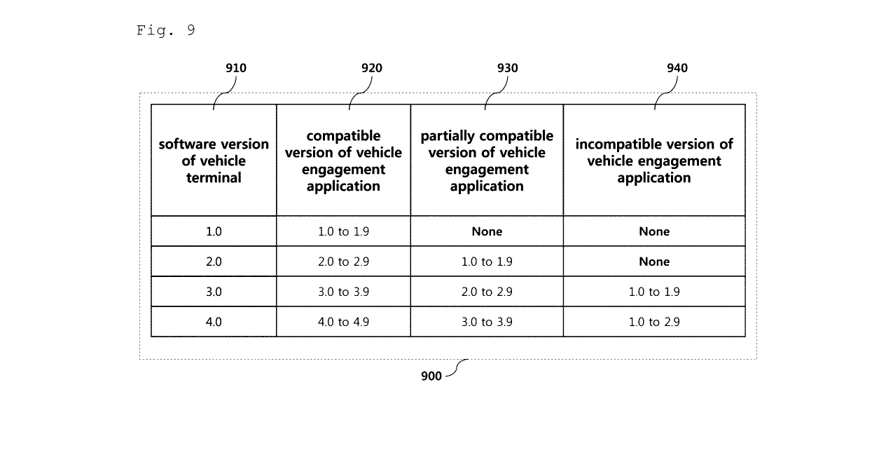

FIG. 8 illustrates a method for managing a vehicle engagement application.

As shown in FIG. 8, in the step S309 (see FIG. 6), if updating the vehicle engagement application is necessary, the vehicle terminal 10 can determine whether the corresponding vehicle engagement application can be automatically updated (S801). For the way of example but not limitation, the vehicle terminal 10 can receive information about automatic update of vehicle engagement application throughout the notification status answer message described in FIG. 6. A user having the mobile device 20 can setup whether to allow automatic update of vehicle engagement application by selecting an option on a predetermined menu.

When it is determined in the step S801 that automatic update of vehicle engagement application is allowed, the vehicle terminal 10 can transmit a predetermined automatic application update request message into the mobile device 20.

The mobile device 20, receiving the automatic update request message, can output a guidance message for showing a progress of automatic update about the corresponding vehicle engagement application, and access to the corresponding application server to download the last version of vehicle engagement application (S809, S810, S811).

Then, the mobile device 20 can install the downloaded vehicle engagement application and automatically run the installed application (S813).

When it is determined in the step S801 that automatic update of vehicle engagement application is not allowed, the vehicle terminal 10 can transmit a predetermined popup request message to the mobile device 20 (S803). Then, the mobile device 20, receiving the popup request message, can generate a popup window including both a predetermined guidance message for informing that there is upgrade of the vehicle engagement application and an application server URL address for accessing to a corresponding application server, and display the popup window on a screen (S805).

FIG. 9 shows a mapping table used at the vehicle terminal for managing a vehicle engagement application.

As shown in FIG. 9, a software mapping table 900 can include fields of a software version of vehicle terminal 910, a compatible version of vehicle engagement application 920, a partially compatible version of vehicle engagement application 930, an incompatible version of vehicle engagement application 940, and so on.

The software version of vehicle terminal 910 can be considered a version of software which is available for installing at the vehicle terminal 10 and engaging with the vehicle engagement application installed at the mobile device 20.

The compatible version of vehicle engagement application 920 can be considered a version of vehicle engagement application which is completely compatible with the version of software at the corresponding vehicle terminal.

The partially compatible version of vehicle engagement application 930 can be considered a version of vehicle engagement application which is partially compatible with the version of software at the corresponding vehicle terminal.

The incompatible version of vehicle engagement application 940 can be considered a version of vehicle engagement application which is totally incompatible with the version of software at the corresponding vehicle terminal, so should be blocked to run.

The vehicle terminal 10, referring to the software mapping table 900, can determine whether it is required to update the vehicle engagement application as well as totally or partially block an execution of the vehicle engagement application when updating the vehicle engagement application is rejected by a user.

Further, referring to the software mapping table 900, the vehicle terminal 10 can determine whether updating the vehicle engagement application is necessary, as well as check compatibility based on the version of software installed at the vehicle terminal and the version of vehicle engagement application currently installed at the mobile device in order to transmit a predetermined control signal, which is for blocking a partial incompatible function or a whole function of vehicle engagement application based on the compatibility determination, into the mobile device.

The aforementioned embodiments are achieved by combination of structural elements and features of the present disclosure in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present disclosure. The order of operations described in the embodiments of the present disclosure may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

It will be apparent to those skilled in the art that various modifications and variations can be made in the present disclosure without departing from the spirit or scope of the disclosure. Thus, it is intended that the present disclosure covers the modifications and variations of this disclosure provided they come within the scope of the appended claims and their equivalents.

What is claimed is:

1. A method performed at a vehicle terminal for managing a vehicle engagement application installed at a mobile device, the method comprising:
establishing a data communication link with a mobile device;
receiving a notification status corresponding to the vehicle engagement application via the data communication link, the notification status indicating whether the vehicle engagement application is up-to-date; and
determining whether it is necessary to update the vehicle engagement application based on the notification status,
wherein a predetermined control signal for managing the vehicle engagement application is transmitted to the mobile device according to the determination.

2. The method according to claim 1, further comprising:
transmitting a notification status request message via the data communication link; and
receiving a notification status answer message in response to the notification status request message.

3. The method according to claim 1, further comprising:
transmitting a predetermined popup request message for presenting a predetermined guidance message for inducing an upgrade of the vehicle engagement application on the mobile device when it is determined that it is necessary to update the vehicle engagement application.

4. The method according to claim 1, further comprising:
transmitting an execution request message for executing the vehicle engagement application into the mobile device when it is determined that it is unnecessary to update the vehicle engagement application.

5. The method according to claim 1, further comprising:
determining whether updating the vehicle engagement application is rejected or blocked when it is determined that it is necessary to update the vehicle engagement application; and
transmitting an execution block request message for blocking execution of the vehicle engagement application in the mobile device when updating the vehicle engagement application is rejected or blocked.

6. The method according to claim 5, wherein:
the notification status includes a number of times which an update notice message corresponding to the vehicle engagement application has been received, and
the updating of the vehicle engagement application is considered rejected when the number of times is greater than a predetermined number.

7. The method according to claim 5, wherein:
the notification status includes setup information regarding whether the updating the vehicle engagement application is blocked, which is set according to a menu selection on the mobile device, and
it is determined whether updating the vehicle engagement application is blocked based on the setup information.

8. The method according to claim 5, further comprising:
outputting a guidance message instructing that use of the vehicle engagement application is blocked on a screen when the updating the vehicle engagement application is blocked.

9. The method according to claim 1, wherein:
the notification status includes version information of the vehicle engagement application, and
whether it is necessary to update the vehicle engagement application is determined by comparing a software version of the vehicle terminal with the version information of the vehicle engagement application.

10. The method according to claim 1, further comprising:
determining whether the vehicle engagement application is automatically updated when it is determined that it is necessary to update the vehicle engagement application; and
transmitting an automatic application update request message for controlling the mobile device to automatically update the vehicle engagement application when the vehicle engagement application is automatically updated.

11. The method according to claim 10, further comprising:
transferring a predetermined popup request message for presenting a predetermined guidance message for inducing upgrade of the vehicle engagement application on the mobile device when it is determined that it is unnecessary to update the vehicle engagement application.

12. The method according to claim 1, wherein:
the notification status includes version information of the vehicle engagement application;
a compatibility is determined based on software version of the vehicle terminal with the version information of the vehicle engagement application; and
a control signal for partially or totally blocking an execution of the vehicle engagement application in response to the determined compatibility is transmitted to the mobile device.

13. A method performed at a mobile device for managing a vehicle engagement application installed at the mobile device, the method comprising:
establishing a data communication link with a vehicle terminal;
receiving a notification status request message from the vehicle terminal;
collecting a notification status corresponding to the vehicle engagement application indicating whether the vehicle engagement application is up-to-date;
transmitting a notification status answer message including the notification status to the vehicle terminal; and
providing a predetermined message for informing that the vehicle engagement application should be updated when a popup request message is received from the vehicle terminal,
wherein the popup request message is transmitted to the mobile device when it is determined at the vehicle terminal that updating the vehicle engagement application is necessary.

14. The method according to claim 13, further comprising:
receiving an execution request message for executing the vehicle engagement application when it is determined at the vehicle terminal that updating the vehicle engagement application is unnecessary; and
executing the vehicle engagement application in response to the execution request message.

15. The method according to claim 13, further comprising:
receiving an execution block request message for blocking execution of the vehicle engagement application,
wherein the execution block request message is transmitted to the mobile device when it is determined at the vehicle terminal that updating the vehicle engagement application is rejected or blocked.

16. The method according to claim 15, wherein the notification status includes a number of times which an update notice message corresponding to the vehicle engagement application has been received, and
the updating of the vehicle engagement application is considered rejected when the number of times is greater than a predetermined number.

17. The method according to claim 15, wherein the notification status includes setup information regarding whether the updating the vehicle engagement application is blocked, which is set according to a menu selection on the mobile device, and
it is determined whether updating the vehicle engagement application is blocked based on the setup information.

18. The method according to claim 15, wherein:
a guidance message instructing that use of the vehicle engagement application is blocked is shown on a screen of the mobile device when the execution block request message is transmitted to the mobile device.

19. The method according to claim 13, wherein:
the notification status includes version information of the vehicle engagement application, and
whether it is necessary to update the vehicle engagement application is determined by comparing a software version of the vehicle terminal with the version information of the vehicle engagement application.

20. The method according to claim 13, further comprising:
receiving an automatic application update request message for instructing automatic update of the vehicle engagement application from the vehicle terminal;
providing a predetermined guidance message for informing a progress of the automatic update;
accessing a server for updating the vehicle engagement application to download a most recent version; and
installing and executing the downloaded most recent version,
wherein the automatic application update request message is transmitted to the mobile device when it is determined at the vehicle terminal that the updating of the vehicle engagement application is necessary and the automatic update is available.

21. A non-transitory computer readable medium storing a program causing a computer to manage a vehicle engagement application installed at a mobile device, the management process performed at a vehicle terminal, the management process comprising:
establishing a data communication link with a mobile device;
receiving a notification status corresponding to the vehicle engagement application via the data communication link, the notification status indicating whether the vehicle engagement application is up-to-date; and
determining whether it is necessary to update the vehicle engagement application based on the notification status,
wherein a predetermined control signal for managing the vehicle engagement application is transmitted to the mobile device according to the determination.

22. A vehicle terminal engaging with a mobile device for managing a vehicle engagement application installed in the mobile device, the vehicle terminal comprising:
a communication unit establishing a data communication link with the mobile device;
a notification status checking module receiving a notification status corresponding to the vehicle engagement application via the data communication link and determining whether it is necessary to update the vehicle engagement application based on the notification status, the notification status indicating whether the vehicle engagement application is up-to-date; and
an installation inducing module generating a popup request message for inducing upgrade of the vehicle engagement application when it is determined to be necessary to update the vehicle engagement application, and transmitting the popup request message to the mobile device.

23. A mobile device engaging with a vehicle terminal, the mobile device comprising:
a communication unit establishing a data communication link with the vehicle terminal;
a notification status informing module receiving a notification status request message from the vehicle terminal, collecting a notification status corresponding to a vehicle engagement application installed at the mobile device, and transmitting a notification status answer message including the notification status to the vehicle terminal, the notification status indicating whether the vehicle engagement application is up-to-date; and
an output unit providing a predetermined popup window for informing that the vehicle engagement application should be updated when a popup request message is received from the vehicle terminal,
wherein the popup request message is transmitted to the mobile device when it is determined at the vehicle terminal that updating the vehicle engagement application is necessary.

24. A system for managing a vehicle engagement application installed in a mobile device, the system comprising:
a vehicle terminal configured to receive a notification status corresponding to the vehicle engagement application, to determine whether it is necessary to update the vehicle engagement application based on the notification status, and to transmit a popup request message to the mobile device based on the determination in order to induce upgrade of the vehicle engagement application, the notification status indicating whether the vehicle engagement application is up-to-date; and
the mobile device configured to collect the notification status corresponding to the vehicle engagement application in response to a notification status request message received from the vehicle terminal, to transmit a notification status answer message including the notification status to the vehicle terminal, and to provide a predetermined guidance message and an application server URL address in order to inform that the vehicle engagement application should be updated when the popup request message is transmitted to the mobile device.
